(19) United States
(12) Patent Application Publication
(10) Pub. No.: US 2017/0076052 A1
(43) Pub. Date: Mar. 16, 2017

(54) METHODS AND SYSTEMS FOR DYNAMIC MANAGEMENT OF A HEALTH CONDITION

(71) Applicants: EMORY UNIVERSITY, ATLANTA, GA (US); THE UNITED STATES GOVERNMENT REPRESENTED BY THE UNITED STATES DEPARTMENT OF VETERANS AFFAIRS, WASHINGTON, DC (US)

(72) Inventors: LAWRENCE S PHILLIPS, ATLANTA, GA (US); CHUN YONG, ATLANTA, GA (US)

(21) Appl. No.: 15/308,160

(22) PCT Filed: May 14, 2015
(86) PCT No.: PCT/US15/30751

§ 371 Date: Nov. 1, 2016

Related U.S. Application Data
(60) Provisional application No. 61/993,385, filed on May 15, 2014.
(60) Provisional application No. 62/116,721, filed on Feb. 16, 2015.

(51) Int. Cl. G06F 19/00; G06F 17/30; G06F 21/62

(52) U.S. Cl. CPC G06F 19/325; G06F 19/322; G06F 21/6245; G06F 19/3431; G06F 17/30312

(57) ABSTRACT

Methods and systems relate to dynamic management of a health condition based on the changing needs and status of individual patient(s) and/or provider(s). The method may include processing information to determine one or more health management factors for a patient; generating a health management plan for managing a health condition of the patient based on the one or more management factors, the management plan including one or more goals, treatment regimen information, one or more prompt conditions, one or more attributes of one or more treatment events, or a combination thereof; and generating one or more prompt(s) based on the management plan.

### RELATED APPLICATIONS

This application claims the benefit of U.S. Provisional Patent Application No. 61/933,385, entitled “Translating What Works—a New Approach to Improve Diabetes Management in Primary Care,” filed May 15, 2014. This application also claims the benefit of U.S. Provisional Patent Application No. 62/116,721, entitled “Methods and Systems For Dynamic Management of a Health Condition,” filed Feb. 16, 2015, both of which are hereby incorporated herein by reference as if fully set forth herein.

### BACKGROUND

Health conditions can lead to patient morbidity, mortality, and costs, as well as health care system resource use and costs. Direct costs related to managing a health condition can include inpatient and outpatient care, medications, among others. Indirect costs can include days off work, decreased productivity, among others.

Most healthcare providers are generally expected to follow standard guidelines to treat a health condition of a patient. While standard guidelines are important, what all patients need is comprehensive, individualized, up-to-date care with optimized case management, including patient education, use of the healthcare team to assist the healthcare provider, and facilitated relay of organized patient data to the healthcare provider to enable appropriate decision-making by the healthcare provider. However, most healthcare providers cannot use these approaches because of technical problems, including a lack of infrastructure and pharmacologic expertise.

Efforts of healthcare providers to treat different diseases are also compromised by infrequent patient visits and limited time during each visit. Patient visits occurring every 3-6 months are too intermittent for proper case management in many instances because the time gap limits patient engagement, i.e., the patient may not recall or emphasize problems that may have occurred months before, and there is typically too little time during visits for staff to provide facilitated relay of patient data.

Lack of critical patient information both during and between patient visits further complicates the healthcare management process. For some diseases, such as diabetes and hypertension, use of patients' home monitoring data to guide clinical decision-making can improve patient outcomes. Although most patients with such disorders do some home monitoring, analyzing the data is labor-intensive and difficult for healthcare providers, and most healthcare providers cannot make appropriate use of such data to inform treatment decisions. Home monitoring data also tends to provide limited information directly to the patient, or information that is difficult for the patient to understand and properly act upon without further support from the healthcare provider.

Moreover, while there are many existing algorithms and computer programs for facilitating healthcare management, these technologies have limited utility because they rely on guidelines that are not individualized and do not account for all possible drug interactions, or the dosages and timing of drug administration during the day. Relying on standardized and possibly outdated guidelines can result in inadequate delivery of proper healthcare, leading to development of disease complications, and associated increases in morbidity, mortality, and costs.

Finally, existing care systems and management by individual practitioners—even those who are specialists—do not permit the profiles, natural histories, and clinical experiences of multiple patients to be collectively analyzed and leveraged in order to better predict and determine the optimal course of treatment for individual patients, in terms of both risk and benefits, which would not be feasible without the use of the envisioned system.

Thus, there is need for systems and methods for enabling dynamic management of a health condition individualized to each patient. What is required is a technical solution that addresses deficiencies in infrastructure and pharmacologic expertise and facilitates optimized case management, including patient education, effective use of the healthcare team to assist the healthcare provider, and facilitated relay of organized patient data to the healthcare provider. The system and method should appropriately incorporate patient home monitoring data and enable frequent communication between the patient, healthcare provider and healthcare team, for example to assist the patient in understanding and acting upon the home monitoring data. The system and method should allow healthcare providers to personalize healthcare management to each patient's preferences and needs, relying on timely, guideline-based, and up-to-date information. The system and method should also incorporate opportunities for the clinical experiences of multiple patients to be leveraged to improve determination of optimal care for individual patients.

### SUMMARY

The disclosed invention relates to systems and methods for dynamically managing a health condition for the changing needs of a patient and/or provider. The systems and methods generate a management plan and determine recommended changes to the management plan based on the individualized needs of a patient and/or provider. In some embodiments, the systems and methods relate to dynamically managing a health condition of a patient based on a management plan. In some embodiments, the systems and methods may include processing information to determine one or more management factors for a patient and generating a management plan for managing a health condition of the patient based on the one or more management factors. The management plan may include one or more goals, treatment regimen information, one or more prompt conditions, one or more attributes of one or more treatment events, or a combination thereof. The systems and methods may also include generating one or more prompts for the patient and/or a provider of the patient based on the management plan. For example, prompts to the provider may indicate the input of updated patient information and/or recommended changes to the management plan based on input patient information or other factors. The provider may then approve or reject any recommended changes to the patient's management plan and/or may make any additional or alternative changes to the patient's management plan. Prompts to the patient may, for example, indicate requests or reminders for input of patient information or may notify the patient of any changes to the management plan.

In some embodiments, the disclosed invention relates to systems and/or computer-implemented methods for performing the various functions described herein for dynamically managing a health condition for the changing needs of a patient and/or provider. In some embodiments, the disclosed invention relates to computer-readable media storing instructions for dynamically managing a health condition for the changing needs of a patient and/or provider. The media may be a non-transitory medium. For example, embodiments of the disclosed invention may be in the form of non-transitory computer readable storage media comprising program instructions stored thereon, wherein the program instructions are executable by a computer to cause the computer to control the management of a health condition by performing the various methods and steps described herein.

Additional advantages of the disclosed invention will be set forth in part in the description which follows, and in part will be obvious from the description, or may be learned by practice of the disclosed invention. The advantages of the disclosed invention will be realized and attained by means of the elements and combinations particularly pointed out in the appended claims. It is to be understood that both the foregoing general description and the following detailed description are exemplary and explanatory only and are not restrictive of the disclosed invention, as claimed.

### BRIEF DESCRIPTION OF THE DRAWINGS

The disclosed invention can be better understood with the reference to the following drawings and description. The components in the figures are not necessarily to scale, emphasis being placed upon illustrating the principles of the disclosed invention.

FIG. 1 shows a block diagram illustrating a system for generating a management plan according to embodiments of the disclosed invention;

FIG. 2 shows a method of generating a management plan according to embodiments of the disclosed invention;

FIG. 3 shows an example of managing a health condition based on a generated management plan according to embodiments of the disclosed invention;

FIG. 4 shows a method of determining a treatment event according to embodiments of the disclosed invention;

FIG. 5 shows a block diagram illustrating an example of a computing system; and

FIG. 6 shows an example of a prompt generated and transmitted to a provider according to embodiments of the disclosed invention.

### DESCRIPTION OF EXEMPLARY EMBODIMENTS

In the following description, numerous specific details are set forth such as examples of specific components, devices, methods, etc., in order to provide a thorough understanding of embodiments of the disclosed invention. It will be apparent, however, to one skilled in the art that these specific details need not be employed to practice embodiments of the disclosed invention. In other instances, well-known materials or methods have not been described in detail in order to avoid unnecessarily obscuring embodiments of the disclosed invention. While the disclosed invention is susceptible to various modifications and alternative forms, specific embodiments thereof are shown by way of example in the drawings and will herein be described in detail. It should be understood, however, that there is no intent to limit the disclosed invention to the particular forms disclosed herein, but on the contrary, the disclosed invention is to cover all modifications, equivalents, and alternatives falling within the spirit and scope of the disclosure.

The disclosed invention relates to methods and systems for dynamically managing a health condition. The disclosed invention can determine a management plan for a health condition based on the current state of and the patient's history with the health condition, other information associated with the patient stored in the patient's profile, preferences of the healthcare provider (“needs”), among others, or a combination thereof. In this way, the disclosure can dynamically adjust the management plan based on changes made to the patient profile and/or the provider's needs in real-time. By way of example, changes to patient information may be input by the patient through a web portal or using a software application, or may be communicated by a home monitoring device, third party provider's system, etc. The disclosed invention can thus guide treatment that is timely and individualized (based on patient-specific data), while controlling the risks associated with the health condition.

The disclosed invention can therefore address many of the difficulties in managing health conditions. For example, many providers have difficulty in understanding and applying guidelines, interpreting the patient's health condition data, and adapting the management plan to changes in the individual's status and behavior. The disclosed invention can provide organized and logically structured decision support to improve the management of a health condition.

According to some embodiments, the disclosed invention provides a method of controlling the management of a health condition that includes the step of receiving input indicating a health marker value for a health marker associated with a health condition of a patient. The input indicating the health marker value may be received, for example, from a healthcare device, which may be any one or more of a self-monitoring marker meter, a medical monitoring device, a drug delivery pump, an activity tracker, a sleep tracker, a smartphone executing a health care application, a weight scale, an exercise machine, a thermometer, a blood pressure cuff or the like. The input indicating the health marker value may also be received from input provided by the patient or from an electronic health record system.

In response to receiving the input indicating the health marker value, a database may be accessed that stores a health condition management plan associated with the patient and the health marker value may be compared to a health marker goal specified in the health condition management plan. The health condition management plan specifies one or more goals, treatment regimen information, and one or more treatment events. As an example, the health condition management plan may be determined in part based on a prior history of the patient with medications currently being taken by the patient and/or a prior history of the patient with medications previously taken by the patient. In some embodiments, the health condition management plan may be determined in part based on profiles of other patients with the same, similar and/or related health condition. Treatment regimen information may include at least one of medication regimen information, dietary regimen information and physical activity regimen information. Each of the treatment events represent a respective change in a state of the health condition of the patient. The health condition management plan may also specify prompt conditions for determining when to generate prompts to the patient and to the provider.

In response to and based on the comparison of the health marker value, it may be determined from the health condition management plan whether at least one of the treatment events has occurred. Then, in response to determining that at least one of the treatment events has occurred, a recommended change in the treatment regimen information may be determined and a prompt may be generated indicating the recommended change to a healthcare provider charged with caring for the patient. The recommended change may be to at least one of the one or more goals, the treatment regimen information, the one or more treatment events and at least one of the prompt conditions specified in the health management plan.

In response to receiving input from the healthcare provider indicating acceptance or modification of the recommended change, a further prompt may be generated indicating instructions to the patient for implementing the recommended change as accepted or modified by the healthcare provider. In some embodiments, additional input may then be received from the patient in response to the further prompt. This additional input from the patient may indicate, for example, agreement or disagreement by the patient with the instructions or a request for further information (e.g., explanation and/or education with regard to the instructions). The health condition management plan may then be updated to reflect the recommended change as accepted, rejected or modified by the healthcare provider and storing the updated health condition management plan in the database.

In some embodiments, the method may be performed iteratively and thus may also include receiving further input indicating additional health condition data about the patient. For example, the further input may be received from the patient, from a patient profile associated with the patient or from an electronic health record system. In response to receiving the further input, the database may be accessed and the additional health condition data may be compared with at least one of the one or more goals, the treatment regimen information, and one or more attributes of the one or more treatment events specified in the health condition management plan. The additional health condition data and the health marker value may also be stored in the profile associated with the patient.

In response to and based on said comparison of the additional health condition data, it may be determined whether at least one other of the treatment events has occurred. In response to determining that at least one other of the treatment events has occurred, a further recommended change may be determined in at least one of the one or more goals, the treatment regimen information, and the one or more treatment events specified in the health condition management plan. In some embodiments, the health condition management plan also specifies prompt conditions for determining when to generate prompts to the patient and to the provider. Thus, the further recommended change may be to at least one of the one or more goals, the treatment regimen information, the one or more treatment events and at least one of the prompt conditions.

Embodiments of the disclosed invention are discussed with respect to the management of diabetes related conditions (e.g., Type I diabetes, Type II diabetes, and pre-diabetes). However, it will be understood that the disclosed invention may be applied to the management of other health conditions. For example, the disclosed invention can apply to the management of any health condition that can be monitored by a health marker (e.g., hypertension, chronic obstructive pulmonary disease (COPD), kidney failure, among others, or any combination thereof). A health marker may relate to one or more measures of biological function associated with a health condition. For example, for diabetes related conditions, the health marker may include glucose level(s). By way of another example, for hypertension, the health marker may include blood pressure; and for COPD, the health marker may include pulmonary function. It will be understood that the disclosed invention may be adapted based on the guidelines for those health conditions.

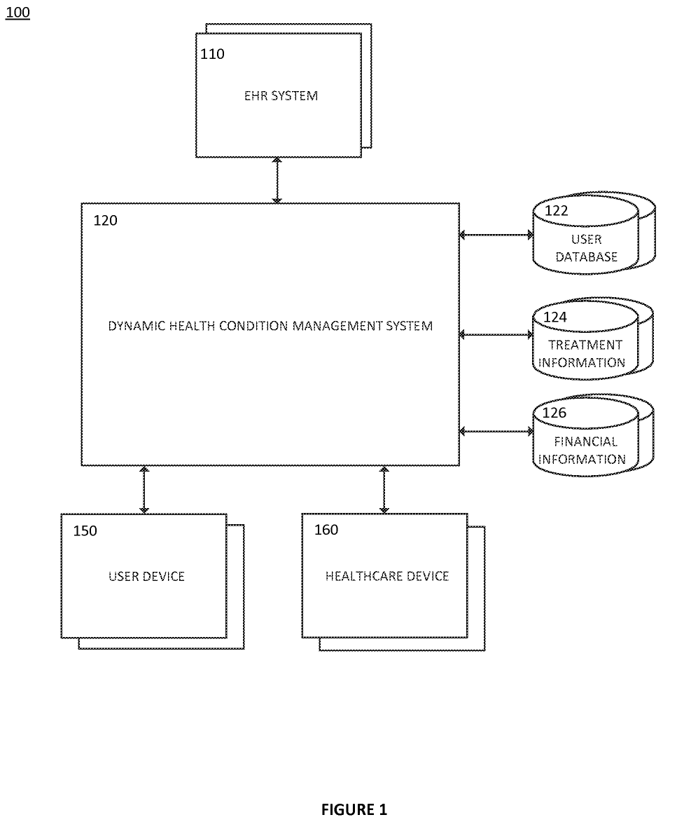

FIG. 1 shows an example of a system 100 capable of dynamically managing a health condition. The system 100 may include any number of systems and/or devices that communicate with other through electrical or data connections (not shown). In some embodiments, the systems and/or devices may be connected via a wired network, wireless network, or combination thereof. In some embodiments, the networks may be encrypted. In some embodiments, the wired network may be, but is not limited to, a local area network, such as Ethernet, or wide area network. In some embodiments, the wireless network may be, but is not limited to, any one of a wireless wide area network, a wireless local area network, a Bluetooth network, a radio frequency network, or another similarly functioning wireless network. In some embodiments, any of the systems and/or devices of the system 100 may be at least in part be based on cloud computing architecture. In some embodiments, the systems and/or devices may be applied to a self-hosted private cloud based architecture, a dedicated public cloud, a partner-hosted private cloud, as well as any cloud based computing architecture.

Although the systems/devices of the system 100 are shown as being directly connected, the systems/devices may be indirectly connected to one or more of the other systems/devices of the system 100. In some embodiments, a system/device may be only directly connected to one or more of the other systems/devices of the system 100.

It is also to be understood that the system 100 may omit any of the systems and/or devices illustrated and/or may include additional systems and/or devices not shown. It is also be understood that more than one device and/or system may be part of the system 100 although one of each device and/or system is illustrated in the system 100. It is further to be understood that each of the plurality of devices and/or systems may be different or may be the same.

In some embodiments, the system 100 may include an electronic health record (EHR) system 110 configured to share an electronic health or medical record of an individual patient or population; a dynamic health condition management system 120 configured to dynamically manage a health condition; a user device 150 configured to communicate with any of the systems and/or devices of the system 100; and one or more medical and/or personal healthcare devices (referred to collectively herein as “healthcare devices” 160) configured to collect information regarding the health condition as well as other health information (e.g., physical activity, diet, etc.).

The EHR system 110 may be any EHR system or electronic medical record (EMR system) capable of sharing a health or medical record information across different health care settings with different stakeholders (e.g., hospitals, labs, clinics, payers, patients, other healthcare organizations or facilities, pharmacy facility, etc.). The record may include a range of health information including but not limited to demographics, medical history, medication and allergies, immunization status, laboratory test results, radiology images, vital signs, personal statistics like age and weight, and billing information. In some embodiments, the EHR system 110 may have the capability of electronically transmitting order(s) for prescriptions, laboratory tests, appointments, among others, to the respective stakeholder.

The dynamic health condition management system 120 may include or have access to one or more databases. In some embodiments, the dynamic health condition management system 120 may include or have access to a user database 122 for storing registered users of the dynamic health condition management system 120, a treatment information database 124 for storing regimen information with respect to one or more health conditions, and a financial information database 126 for storing payer and formulary information. In some embodiments, the dynamic health condition management system 120 may include any number of different database(s).

In some embodiments, the user database 122 may include user profiles of any user of the health management system. For example, a user may include but is not limited to a patient, a provider, or a combination thereof. In some embodiments, each patient profile may include patient information (contact information, insurance information, etc.), provider information (e.g., contact information, insurance information, etc.), any information associated with the health condition management plan, the health condition management plan, among other types of information, or a combination thereof.

In some embodiments, the treatment information database 124 may include treatment regimen information, such as but not limited to medicine regimen recommendations (e.g., one or multiple medications and dosage (s)), dietary recommendations, exercise or other physical activity regimen recommendations, among others, or a combination thereof.

In some embodiments, the financial information database 126 may include payer information. For example, the payer information may include medical insurer or insurance company information such as respective coverage details, copays and formulary tiers. In some embodiments, the payer information may be arranged in different categories based on coverage and formulary tiers. In some embodiments, the payer information may include the patient's personal payment information, including credit or debit card numbers and the like.

The user device 150 may be a device configured to communicate with the dynamic health condition management system 120, EHR system 110 and health monitoring devices 160. The user device 150 may include mobile devices (e.g., any cellular phone, smart phone, wireless phone), other mobile computing devices, such as laptop computer, notebook computer, netbook computer, tablet, a desktop computer, and/or other computing devices. Any user (e.g., patient, provider, etc.) may use a user device 150 to interface with the dynamic health condition management system 120 and/or the databases 122, 124 and 126 using appropriate software applications.

Although the term “healthcare provider” is often used herein in reference to a physician (such as an M.D. or D.O.), it should be appreciated that the term can equally be applicable in many contexts to other healthcare professionals, such as a physician's assistant, nurse practitioner, or pharmacist. Therefore, the term “healthcare provider” or “provider,” as used herein, is not intended to be limited to physicians. Similarly, the term “patient,” as used herein is intended to broadly include a patient himself or herself and/or any other persons responsible for the actions/decisions of the patient (e.g., parents of child patients, adult children of elderly patients, or other guardians, custodians or persons holding medical power of attorney over a patient, etc.).

In some embodiments, the user device 150 may include an application suite that can perform all or a portion of the functions of the dynamic health condition management system 120. In some embodiments, the application suite may include any type of application that can be executed on the user device 150. The application suite can include a dynamic health condition management application and can also include client programs (e.g., calendar applications, communication applications, Internet browsing applications, etc.), services, or the like that utilize or interact with the dynamic health condition management system 120 or other services, applications, content, etc. available over the communication network(s). In some embodiments, a dynamic health condition application performing all or a portion of the functions of the dynamic health condition management system 120 may be downloadable. In one embodiment, the dynamic health condition management system 120 may interface with one or more of the applications on the user device 150 to perform one or more functions described herein.

In some embodiments, the system 100 may include one or more healthcare devices 160. The one or more healthcare devices 160 may be physical devices and/or applications configured to collect and/or transmit health information. As an example, healthcare devices 160 may be medical devices such as self-monitoring marker meters, drug delivery pumps, among others, or a combination thereof. For example, for management of diabetes, medical devices can include but are not limited to blood glucose meters, continuous glucose monitors, alternative glucose-related monitoring systems, ambulatory insulin infusion pumps, diabetes analysis application(s) or software, diabetes device configuration application(s) or software, or a combination thereof. Healthcare devices 160 can include any personal health care device capable of transmitting and/or collecting health information. Personal health care devices can include but are not limited to smartphones, weight scales, personal activity trackers, diet or nutrient intake trackers, sleep trackers, pedometers, exercise machines, thermometers, weight or exercise management application software, blood pressure cuffs, watches, contact lenses or glasses with integrated sensors, or a combination thereof. In some embodiments, the one or more healthcare devices 160 may also or alternatively be one or more applications executed on a user device 150 (e.g., smart phone, tablet or personal computer).

The dynamic health condition management system 120 may be configured to dynamically manage a health condition based on the patient's profile, and the provider's preferences with respect to management of a patient's health condition. For example, a patient's profile may include information related to factors that reflect comorbidities, attitude, and the level of glucose monitoring, and the provider's preferences may include the conditions for receiving a report (e.g., status updates) for individual patients, a group of patients, or a combination thereof. The patient and/or the provider may be considered to be a “user” of the dynamic health condition management system 120 and information associated with the patient and/or provider may be stored in a user database 122 (e.g., as a patient profile or a provider profile, as applicable).

In some embodiments, the dynamic health condition management system 120 may generate a health condition management plan specific to the patient's profile and/or provider's preferences. The dynamic health condition management system 120 can account for the patient's health condition states using algorithms that consider, among other things, one or more factors stored in the patient's profile and related to the patient's medical, personal, and/or financial information when generating the health condition management plan. The one or more factors may include any information associated with management of a health condition. By way of example, the dynamic health management system 120 can manage the health condition of a young, generally healthy patient with a long life expectancy possibility differently from the health condition of an older, relatively sick patient with multiple comorbidities and a reduced life expectancy.

In some embodiments, the health condition management plan can include a treatment regimen, one or more goals and one or more prompt conditions. In some embodiments, the treatment regimen, the one or more goals, and/or the one or more prompt conditions may be based on the one or more factors stored in the patient's profile. In some embodiments, the treatment regimen may include a medication regimen (e.g., dosage and specific medication), dietary and/or physical activity regimen, among others or a combination thereof.

In some embodiments, the one or more goals may include one or more health marker goals, one or more performance goals, among others, or a combination thereof. The one or more health marker goals may relate to goal(s) for a patient for one or more health markers (e.g., a measure of biological function associated with the health condition). The one or more performance goals may relate to biologic and non-biologic goal(s) related to health condition management. For example, one or more performance goals may include one or more goals for a patient with respect to responding to prompts, to meeting the one or more health marker goals, to adhering to the treatment regimen (e.g., successfully taking the medication, marker testing, following a diet, etc.), among others, or a combination thereof.

In some embodiments, the one or more prompt conditions may control when the dynamic health condition management system 120 generates a prompt for the patient and/or provider. A “prompt” may be any message, alert, user interface, etc. for conveying and/or collecting information regarding the health condition or management plan, that can be provided, for example, by electronic alerts, text, and/or email.

In some embodiments, there may be at least two types of prompts—routine prompts and additional prompts. Routine prompts may relate to a routinely scheduled date/time related collection of/providing information to patient and/or provider. By way of example, for a routine prompt for a provider, the dynamic health condition management system 120 may generate a report providing a summary of information related to a health condition (e.g., blood glucose levels over a week) for one or more patients based on a schedule. By way of another example, for a routine prompt for a patient, the dynamic health condition management system 120 may generate a user interface for collecting information regarding the health condition based on a schedule. Additional prompts may relate to a prompt generated in response to a determined health condition status and/or change in health condition status, for example, based on information collected in a routine prompt.

In some embodiments, one or more prompt conditions may relate to the schedule of routine prompts (frequency, time/date, etc.), content of routine prompts, conditions for transmission of additional prompts, content of additional prompts, a method of transmission (e.g., email, message, alert notification, etc.), or a combination thereof for transmitting a prompt to a patient and/or provider.

In some embodiments, the treatment plan may include one or more attributes of a treatment event. A treatment event can represent any change in state of the health condition that relates to the effectiveness of the generated health management plan. For example, one or more treatment events may relate to a change in one or more management factors (e.g., pregnancy, different insurance company, etc.), change in health condition status (e.g., hypoglycemic event), change in performance, among others, or a combination thereof. The dynamic health condition management system 120 may determine one or more attributes for each treatment event. The attributes can help to define the treatment event. For example, the attributes for each treatment event may include but are not limited to frequency of occurrence, a wider range for the goals, among others, or a combination thereof. The determination of a treatment event can alert the dynamic health condition management system 120 that the treatment plan may need to be adjusted.

In operation, the treatment regimen can relate to the details of the treatment, the one or more goals can relate to management objectives and the one or more prompt conditions and/or the attributes of the one or more treatment events can relate to the level of monitoring of efficacy or effectiveness of a management plan in managing the health condition of a patient. The dynamic health condition management system 120 can dynamically adjust the health condition management plan based on the determined efficacy or effectiveness of and/or performance with the health condition management plan, for example, by changing the one or more prompt conditions; and thereby the system 120 can change the level of monitoring of the health condition. For example, if the dynamic health condition management system 120 determines that the management plan is effective (e.g., the patient complies with the performance goals and/or health marker goals), then the dynamic health condition management system 120 may adjust the one or more prompt conditions, for example, by reducing the frequency of the prompts to the patient and/or to the healthcare provider and healthcare team. By way of another example, if the dynamic health condition management system 120 determines that the management plan is not effective (e.g., the patient does not comply with the performance goals and/or health marker goals and/or one more factors change), the dynamic health condition management system 120 may adjust the one or more prompt conditions, for example, by changing the treatment regimen, changing the frequency of the prompts to the patient and/or to the healthcare provider and healthcare team, etc. In this way, the one or more goals and/or one or more prompt conditions in conjunction with the one or more attributes of one or more treatment events can provide a structured, adaptive basis on which the dynamic health condition management system 120 monitors the efficacy or effectiveness of a treatment regimen of a health condition for a patient.

### I. HEALTH CONDITION MANAGEMENT PLAN

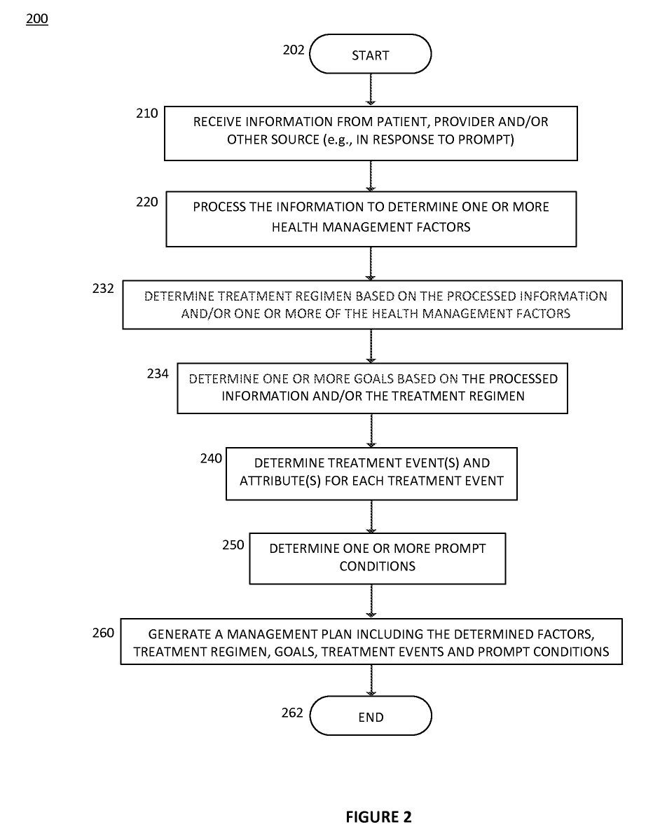

FIG. 2 shows a method 200 of generating a health condition management plan. In some embodiments, the method 200 may begin when a patient becomes a registered user of the dynamic health condition management system 120. In some embodiments, the provider may be a registered user of the dynamic health condition management system 120 and may add the patient as a registered user of the dynamic health condition management system 120. In some embodiments, the provider may add the patient to the dynamic health condition management system 120, for example, by adding the patient from the EHR system 110, from the user device 150, devices 160, among others, or any combination thereof. In some embodiments, the patient may request through the EHR system 110 and/or the user device 150 to be registered. During the registration process, the patient can select the provider or be assigned to a default provider. When the patient is registered, the provider and/or patient may also be informed. By registering a patient, a patient profile for the patient is created and stored in the user database 122.

In some embodiments, the method 200 may include a step 210 of receiving information collected and/or received through prompts from the provider, healthcare team and/or patient, the EHR system 110, healthcare devices 160 (e.g., weight scales, exercise machines, blood glucose monitors, etc.), other personal healthcare applications (e.g., a fitness and/or diet daily log) disposed on the user device 150, etc., or any combination thereof. In some embodiments, during the registration process, the dynamic health condition management system 120 may generate prompts for requesting information from the patient, the provider, the healthcare team and/or the EHR system. In other embodiments, the dynamic health condition management system 120 may utilize and/or “read in” all or some of the information provided on an electronic or a paper questionnaire. The information received may be stored in the user database 122, for example, with the associated patient profile.

A. Factor(s)

The method 200 can include a step 220 for processing the received information with respect to one or more health management factors. Processing the received information may include, for example, parsing and analyzing the information to determine the identified or represented health management factors. The information associated with these factors may be stored and associated with the respective patient profile in the user database 122. In some embodiments, the one or more health management factors may include the state of the health condition (referred to as “health condition state”), as well as individual patients' general health status, life expectancy, lifestyle, occupation/education, performance (e.g., with respect to dealing with the health condition), medications, and financial considerations, among others, or a combination thereof.

In some embodiments, the health condition state factor may include any information associated with the health condition including but not limited to: current and historical health marker data for any health marker associated with the health condition (e.g., level, collection data and time and associated information), date of diagnosis, history of related conditions associated with the health conditions; among others, or a combination thereof. For example, for diabetes, the information for the health condition state factor may include: the month/year of diabetes diagnosis, A1c levels and dates, fasting glucose levels and dates, glucose profiles and dates, creatinine levels and dates, glucose historical data (e.g., history of hyperglycemia, history of hypoglycemia, conditions associated with instances of hyperglycemia and/or hypoglycemia, etc.), glucose levels associated with collection timeframe, other information associated with the levels (e.g., previous meal, physical activity, etc.), among others, or a combination thereof.

In some embodiments, the dynamic health condition management system 120 may process related information to determine a qualitative or quantitative value representing a health condition state of a patient. In some embodiments, the health condition state factor may include contributions from average health marker value(s) associated with the health condition, risk and/or frequency of one or more characterizing health states associated with the health condition for a patient, among others, or a combination thereof. For example, with respect to diabetes, the characterizing health states may include hypoglycemia and/or hyperglycemia. In this example, the dynamic health condition management system 120 may determine that a patient has a low risk of hypoglycemia, a moderate risk of hypoglycemia, and/or a high risk of hypoglycemia based on the data provided.

In some embodiments, the general health status factor may include any information relating to a patient's general health status, other health conditions and/or other health condition history (e.g., past surgery), among others, or any combination thereof. For example, information relating to the patient's general health status may include sex, race, ethnicity, group, blood pressure, height, weight, BMI, allergies, among others, pregnancy, lactation, trying to get pregnant, or any combination thereof. The information relating to other health conditions and/or history may include but is not limited to: history of heart conditions and/or heart surgery (e.g., congestive heart failure; and coronary artery disease); neurological diseases, GI surgery and condition (e.g., irritable bowel disease), active infections, among others, or a combination thereof. The information included in the general health status factor may be associated with respective collection dates and/or incidence dates, if applicable. For example, the blood pressure may be associated with respective dates collected. In some embodiments, the dynamic health condition management system 120 may determine a qualitative or quantitative value representing a general health status of a patient (e.g., good health, moderate health, poor health, etc.) and/or risk of specific complications (e.g., risk of vascular complications), based on the information associated with the general health status factor and/or health condition factor.

In some embodiments, the life expectancy factor may include any relevant information regarding the estimated years of life remaining for a patient, such as the family history, presence or absence of disease complications, and/or clinically significant comorbidities. In some embodiments, the life expectancy factor may correspond to a qualitative or quantitative value representing a range of one or more years. By way of example, the life expectancy factor may include periods corresponding to very high life expectancy (more than 30 years), high life expectancy (20-30 years), moderate life expectancy (10-20 years), low life expectancy (5-10 years), very low life expectancy (0-5 years), etc. In some embodiments, the life expectancy factor may be provided by a provider. In other embodiments, the health condition management system 120 may determine the life expectancy based on information associated with one or more of the other factors (e.g., age, health condition status, general health status, etc.). For example, a patient might be mentally and physically vigorous despite already being 92 years old, with many members of his/her family who lived to be 100, while a much younger patient may have a cancer which usually doesn't allow survival for 5 years.

In some embodiments, the performance factor may include information related to a history of the patient's biologic and non-biologic performance with respect to the management plan of a health condition. For example, the performance factor may include but is not limited to the frequency of the patient achieving health marker goals (e.g., health marker levels within a target range), and adherence or compliance with a requested schedule for providing information associated with a health condition (e.g., home blood glucose testing by the patient), following a diet, etc. In some embodiments, the performance factor may include a value representing an overview of performance with respect to achieving marker goals and/or adhering to the health condition management plan (e.g., regular or infrequent tests, follows exercise routine, etc.). In some embodiments, the dynamic health condition management system 120 may determine the performance factor based on the information provided with the health condition and/or responses to the prompts.

The lifestyle factor may include any information related to demographics and/or lifestyle of a patient. The lifestyle factor may include but is not limited to information related to current or planned dietary and/or exercise habits, emotional/stress levels, travel activity, alcohol/drug use/smoking status, hour(s)/quality of sleep, resources and/or support system, among others, or a combination thereof.

The occupation factor may include any information related to the occupation of a patient, such as current education level and current/planned occupation. For example, the occupation information can be used to identify potential problems with medications and/or medication regimens that may make it difficult for a patient to perform his/her usual job (e.g., meal time insulin use in interstate truck drivers). This information, for example, can be used to select medications and/or medications regimens.

In some embodiments, the financial considerations factor may include information such as insurance and/or payment information, for example, that relates to financial aspects of managing a health condition. In some embodiments, the financial considerations factor may include information about levels of insurance coverage and status of medications within formularies associated with each level of insurance coverage. For example, the different levels may include bronze, silver, and gold. In some embodiments, the dynamic health condition management system 120 may determine the level of insurance coverage and/or the associated level of formulary based on information input by the patient, provider, the EHR system 110, among others, or a combination thereof. In some embodiments, the level of insurance coverage and the associated level of formulary; or any combination thereof may be selected by and/or determined for each patient, including considerations of priorities with regard to out of pocket expenses. By way of example, a “bronze” level insurance plan and “gold” level formulary may indicate that the patient may be willing to pay for a medication considered to be in a “gold” level formulary while the patient is on the “bronze” plan, which may result in a greater copay. In this way, the dynamic health condition management system 120 can direct and/or inform patients and providers regarding the use of different medications and related health costs associated with the management of the health condition.

In some embodiments, the medication factor may include any information relating to medications used and/or prescribed currently and previously to the patient. By way of example, the medication factor may include medication allergies, medications and/or doses previously prescribed to the patient, related history with previously prescribed medications, etc.

In some embodiments, the dynamic health condition management system 120 may associate the information associated with one factor with information associated with another factor to enrich the history of the health condition. By way of example, the medication factor may be associated with the health condition factor, for example, so that the dynamic health condition management system 120 may associate a medication and dose with a health marker value(s).

In some embodiments, the dynamic health condition management system 120 may process the information associated with one or more health management factors to generate a health condition management plan for that patient. In some embodiments, the dynamic health condition management system 120 may begin with a default health condition management plan and adjust accordingly (steps 232-250) based on the information associated with one or more factors.

B. Treatment Regimen Information

In some embodiments, the method 200 may include a step 232 of determining the treatment regimen based on the processed information and/or one of more of the health management factors. In some embodiments, the health condition management system 120 may directly determine the treatment regimen (e.g., medication regimen) from the information provided by the user, provider, and/or EHR 110. In some embodiments, the health condition management system 120 may determine the treatment regimen and/or recommendations to change the treatment regimen provided by the patient and/or provider based on the treatment information stored in the treatment information database 124, information associated with the one or more factors, among others, or a combination thereof. For example, the treatment regimen for younger, healthier, more adherent patients who have diabetes might include more aggressive use of insulin, with specific recommendations for kind of insulin, dosage, and timing of administration, as compared to older, less healthy, less adherent patients, for whom use of insulin might carry less potential for benefit and more risk of the adverse side effect of hypoglycemia.

C. One or More Goals

In some embodiments, the method 200 may include a step 234 of determining one or more goals based on the processed information and/or the treatment regimen. The one or more goals may include one or more health marker goals, one or more performance goals, or a combination thereof. In some embodiments, the one or more goals may include additional and/or alternative goals. The goals may be based on the needs of the patient and/or provider.

In some embodiments, a health marker goal may correspond to a value and/or a range of value(s) specific to one or more health condition markers. In some embodiments, one or more health marker goals may be specific to a collection period. The collection period may correspond to one or more time categories (e.g., pre-meal, post-meal, 24 hours, etc.). In some embodiments, the one or health marker goals may include a goal for more than one category in a collection period, for more one or more health condition markers, or any combination thereof. For example, for diabetes, the health marker goal(s) may include a goal for pre-meal blood glucose levels, a goal for post-meal glucose levels, a goal for A1c, among others, and/or a combination thereof. In some embodiments, the collection period may be related to a specific date and/or period.

In some embodiments, the dynamic health condition management system 120 may determine the health marker goal(s) from treatment guidelines (e.g., saved in the treatment information database 124), one or more factors, or a combination thereof. By way of example, the health condition management system 120 may adjust a default health marker goal (for example, according to treatment guidelines) based on the health condition factor and/or life expectancy factor. By way of example, for a patient who has diabetes but has a high risk of hypoglycemia and low life expectancy, the health condition management system 120 may raise the range of glucose values recommended in the standard guidelines for one or more categories (e.g., pre-breakfast) in the collection period based on those factors. Such recommended adjustments may be computed by execution of algorithms which take into consideration both the specific clinical condition of individual patients (for example, whether or not the patient has abnormal kidney function and/or a history of coronary heart disease), the patient's current medications (for example, use of insulin carries an increased risk of hypoglycemia), and the patient's prior history of hypoglycemia (for example, with use of different medications and particular dosages of such medications), as well as the patient's individual preferences, history and expectations of adherence to management recommendations. The algorithms may also utilize analysis of the profiles, natural histories, and clinical experiences of multiple patients in order to leverage such information to allow the recommended adjustments in the treatment plan for an individual patient to be optimized in terms of both minimizing risk (e.g., helping to reduce risk of hypoglycemia for a patient with diabetes) and maximizing the likelihood of benefit (e.g., helping to obtain better glucose control for a patient with diabetes).

The performance goal(s) may relate to one or more values related to a patient's biologic and/or non-biologic performance of a management plan, for example, with respect to one or more health marker goals and/or collection schedule (e.g., addressing prompts for information). For example, the performance goal(s) may include a number of times that the patient meets one or more health marker goals, a number of times one or more health marker goals are not met (e.g., a certain health state), a number of times a response to prompt and/or amount information in the response is received, among others, or any combination thereof. In some embodiments, the one or more performance goals may be related to a specific date, category and/or collection period.

D. Treatment Event(s)

In some embodiments, the method may include a step of 240 of determining one or more treatment events specific to a health condition and one or more attributes for each treatment event. In some embodiments, the one or more treatment events and/or one or more attributes of each treatment event for a health condition may be predefined in the treatment information database 124. In some embodiments, one or more attributes may be adjusted based on the one or more health management factors, the one or more goals, the treatment regimen information, or a combination thereof. For example, for a patient who has terminal cancer with an estimated life expectancy of five years, the system 120 may adjust the attributes associated with hyperglycemia by increasing the threshold for frequency of occurrences. In this way, the patient as well as the provider may not be burdened with a prompt for every occurrence of hyperglycemia, and prompts might be targeted to management of hyperglycemia only when it reaches a level that can further impair the patient's quality of life.

In some embodiments, one or more attributes for certain treatment events may not be capable of being adjusted and thus any information received from a patient (or other source) indicating a change in such attributes may always be considered to be a treatment event. One example of a non-adjustable treatment event could be a change in the information associated with the financial factor (e.g., new insurance company). A change in this factor could change the medication regimen used to manage the health condition and thereby can result in an adjustment of one or more goals and/or one or more prompt condition goals.

There may be any number of attributes and/or treatment events. In some examples, the treatment events may include at least the different states of a health condition. For example, for diabetes, there may be at least three different states of a health condition—hyperglycemia, hypoglycemia and within goal. In this example, the dynamic health condition management system 120 may define attributes of each of these events, for example, by a health marker range, explanatory reasoning (e.g., explanations considered to be potentially contributable to a state (e.g., taking insulin but skipping a meal potentially contributing to hypoglycemia)), initial occurrence or recurrence of a state, and frequency of occurrence of a state, among others, or combination thereof.

For example, for a diabetic patient, the dynamic health condition management system 120 may determine that hyperglycemia (one or more glucose levels above the health marker goal) is to be considered a treatment event for a patient when the difference between the glucose level and the health marker goal is above the goal plus a determined range and/or the frequency of the high glucose level is above a certain number. In this example, the difference (threshold) and the frequency may be considered to be attributes of the treatment event (hyperglycemia). In this way, a patient and/or provider may not be burdened with a prompt for a very minor anomaly, but the dynamic health condition management system 120 can cause a prompt to be generated for either a single very high glucose level or several more modestly elevated glucose levels.

In some embodiments, one or more of treatment events may be ranked by relative priorities for correction, for example, according to their impact on the health condition. For example, for diabetes, a treatment event may be defined by relative priorities as follows: a severe hypoglycemic event (resulting in loss of consciousness), a mild hyperglycemic event (a glucose level above goal but not in a life-threatening range), a change in information associated with certain factors (e.g., report of a pregnancy), certain medication changes (e.g., use or discontinued use of a steroid), change in financial status (e.g., insurance plan change), among others, or a combination thereof.

E. One or More Prompt Conditions

In some embodiments, the method 200 may include a step 250 of determining one or more prompt conditions based on at least the processed information, one or more goals, and/or treatment regimen.

In some embodiments, the dynamic health condition management system 120 may adjust default prompt condition(s) based on one or more goals and/or management factors. By way of an example, the dynamic health condition management system 120 may provide a patient who has glucose levels that are consistently within the goal range, fewer routine prompts than a patient who is consistently outside of goals. In this example, the patient who is consistently within goals may have no limit of other prompts and the patient that is consistently outside of the goals may have a limit of other prompts. In this way, the dynamic health condition system 120 can individualize management, i.e., by directing broader patient education and engagement at patients who are achieving goals, and directing more targeted patient prompts for glucose testing at patients who have yet to achieve their high priority management goals. Overall, this can help to better manage patients.

In some embodiments, the content may include but is not limited to treatment recommendations, reports of the health condition status for a collection period, requests for information, among others, or combinations thereof. In some embodiments, the transmission method may be determined from information indicated in the user profile.

F. Health Condition Management Plan

In some embodiments, the method 200 may include a step 260 of generating a health condition management plan. As discussed above, the health condition management plan may include the treatment regimen, the one or more goals, the one or more prompt conditions, the one or more treatment events and associated attributes, among others, or a combination thereof.

In some embodiments, the method 200 may end at step 262 by storing the health condition management plan, for example, in the user database 122. In some embodiments, the management plan may be stored in the user database 122 in an associated manner with the patient profile and/or provider profile. In other embodiments, the system 120 may store the health condition management plan locally on a user device 150 and/or the dynamic health condition management system 120. In some embodiments, the dynamic health condition management system 120 can determine when and how to generate and transmit prompts to users, e.g., patients and/or respective provider, and the content for the prompts, based on the generated management plan.

### II. MANAGEMENT OF A HEALTH CONDITION ACCORDING TO A GENERATED HEALTH CONDITION MANAGEMENT PLAN

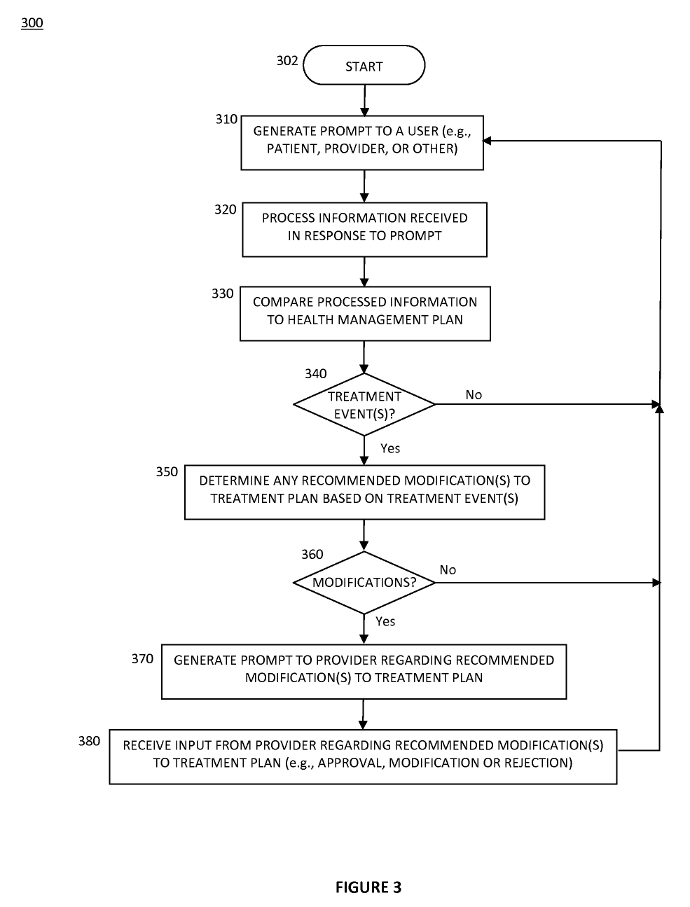

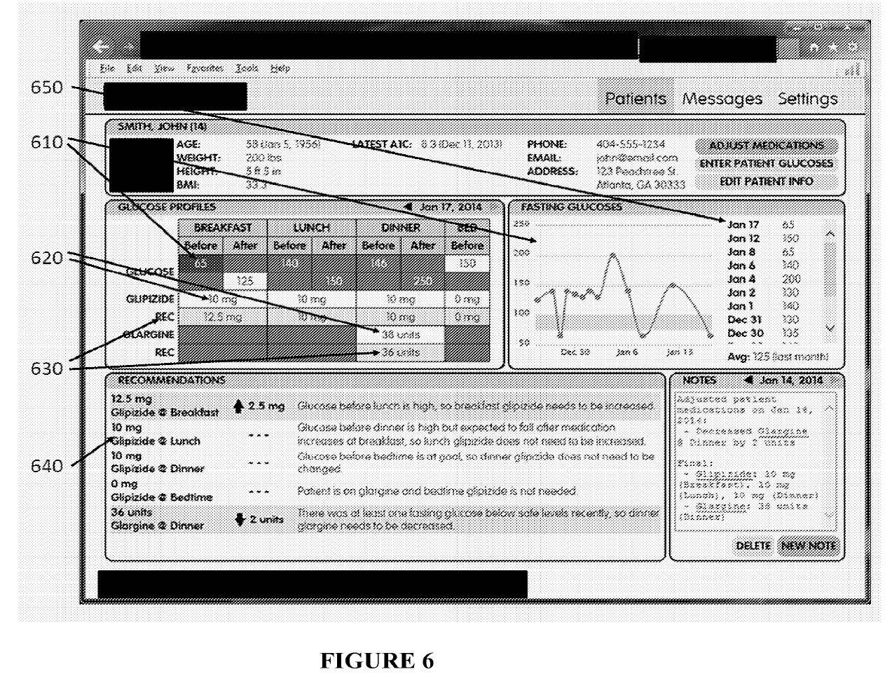

FIG. 3 shows a method 300 of managing a health condition based on a generated plan, for example, by method 200 in FIG. 2. In some embodiments, the method 300 may include a step 310 of generating a prompt to a user based on the management plan. The step 310 may include generating a prompt according to the one or more prompt conditions determined in FIG. 3. By way of example, the prompt may be a routine prompt generated for a patient and/or provider. In this example, the prompt may be generated for a patient, for example, to collect health condition data (e.g., glucose data) based on a schedule. In yet another example, the prompt may be generated for a provider, for example, to provide the provider with a report of the status of the management of a health condition for a patient, which might include recommendations for changes in the health management plan, for example, as shown in FIG. 6.

In some embodiments, the method 300 may include a step 320 of processing information received in response to the prompt in step 310. In some embodiments, the dynamic health condition management system 120 may process the received transmission to determine which information has been added. In the example above, the information received may include fasting glucose data. In another example, the provider may have manually adjusted the medications. In some embodiments, the dynamic health condition management system 120 may automatically update the prompt in response to information provided. For example, if the patient provides a glucose value that is outside of the goal, the dynamic health condition management system 120 may automatically request additional information, such as possible reasons for a glucose level which is below or above goal (e.g., dietary, exercise, etc.). All of the information provided by the patient and/or provider in response to a prompt may be processed by the dynamic health condition management system 120. For example, information about the glucose levels received manually or automatically via a glucose measuring device from a patient with diabetes may be processed using algorithms to determine whether the level meets criteria for a “red flag” alert to the healthcare team and healthcare provider (e.g., if the level is particularly high or low relative to that patient's individualized glucose goals), then if not, assessed for measurement within the individualized frequency of measurement recommended for that patient or not, and if the glucose value is or is not within the individualized goal range for that patient, etc.

It should be understood that in some embodiments, step 320 may additionally or alternatively involve processing information that is received not in response to a prompt. For example, information may be received at any time from a patient (such as medication use information or symptoms of hypoglycemia), or may be received automatically from a user device such as a glucose meter or insulin pump or activity tracker, or may be received from an EHR system 110 (such as information regarding an abnormal kidney function test or a positive pregnancy test). Furthermore, after any initially received information is processed, the system algorithms might result in a prompt to the patient, healthcare team, provider or other source to obtain/input additional information.

In some embodiments, the method 300 may include a step 330 of comparing the processed information to the generated management plan. By way of example, the dynamic health condition management system 120 may compare the processed information to one or more goals, treatment regimen, among others, or a combination thereof. As above, for a glucose level for a patient with diabetes, the system algorithm comparisons would include assessment in terms of both frequency of measurement relative to the individualized goals for each patient, and the glucose level relative to the individualized goals for each patient.

In some embodiments, the method 300 may include a step 340 of determining whether the comparison of the processed information to the health management plan indicates a treatment event. In some embodiments, the dynamic health condition management system 120 may compare the processed information to one or more of one or management goals, treatment plan information and/or one or more management factors to determine whether the processed information corresponds to one or more attributes of a treatment event (e.g., hypoglycemia, change in pregnancy status, etc.). For example, the system 120 may determine that the processed information indicates characteristic(s) of a relative state of the patient's health condition (e.g., mild hyperglycemia vs. severe hyperglycemia). In this way, the health condition management system 120 may determine whether a treatment event has occurred. The system 120 may also determine or assess the efficacy, effectiveness and/or or safety of the patient's health condition management plan based on contributing factors such as the type and nature of a treatment event (or the fact that an expected treatment event did not occur), whether or not any performance goals are obtained, and whether or not improvement is seen with regard to other metrics relating to the health management plan. In some embodiments, steps 330 and 340 may be performed in the same step. In some embodiments, steps 330 and/or 340 may be based on the ranked priority of (importance of) one or more treatment events.

If it is determined at step 340 that one or more treatment events have occurred, the method 300 moves to step 350, where any recommended modifications to the treatment plan are determined. By way of example, if the treatment event is relative hypoglycemia (blood glucose below thresholds appropriate for individual patient(s), as determined with the management plan), the dynamic health condition management system 120 may determine a recommendation for changes to the medication regimen for a patient. The dynamic health condition management system 120 may generate a recommended new management plan based on the recommended changes to the medication regimen.

In some embodiments, the dynamic health condition management system 120 may be configured to analyze the profiles, natural histories, and clinical experiences of multiple patients and leverage that information to allow any recommended modifications in an individual patient's treatment plan to be optimized in terms of both minimizing risk (e.g., helping to reduce risk of hypoglycemia for a patient with diabetes) and maximizing the likelihood of benefit (e.g., helping to obtain better glucose control for a patient with diabetes). For example, identifying patterns across multiple patent profiles showing reduced risk of hypoglycemia during the night when patients with diabetes take their injections of a certain kind of long-acting insulin before their evening meal compared to taking it at bedtime would permit recommendations of initial use of this medication for an individual patient to be optimized, improving the quality of the delivery of care by healthcare providers to their patients.

If it is determined at step 360 that any modifications are recommended to the management plan, the method advances to step 370, where a prompt is generated and transmitted to the provider to alert the provider of the recommended modifications. Input is then received from the provider at step 380 regarding the recommended modifications. For example, the input from the provider may indicate the provider's approval, rejection and/or further modifications of the recommended modifications to the treatment plan. It should be appreciated that, in some embodiments, the provider may have pre-authorized certain changes or types of changes to a treatment and, therefore, the steps 370 and 380 may not be necessary or desired. However, in most cases, review and approval by the provider should normally be achieved before any material change is made to a patient's health management plan.

In some embodiments, before a prompt is transmitted to a provider, a prompt may first be generated and transmitted to the patient to solicit any additional comments that the patient may wish to provide. Additional relevant information about the patient may also be ascertained from the patient's profile. Thus, a prompt to the provider may specify not only recommended changes to the management plan, but also any comments from the patient and/or important elements of the patient's history and current/past medical conditions and other relevant information for the provider to consider.

After receiving input from the provider at step 380, or if no modifications to the management plan were recommended at step 360, or if no treatment events were determined in step 340, the method 300 may return to step 310 to generate another prompt for the user. By way of example, if the prompt follows a treatment event and an associated modification to the management plan, the prompt may alert the patient to the modified management plan. In the case where the prompt follows a treatment event without an associated change to the management plan, the prompt may serve to provide education information to the patient and/or to alert the patient when it is again time to input patient information (e.g., updated blood glucose level for a patient with diabetes). In situations where no treatment event is determined to have occurred, the next alert may be generated for the patient and/or the provider to provide status information, educational information, an indication that additional patient information (e.g., explanatory reasoning) is needed, etc. As discussed, the generation of a prompt to a user may be based on the one or more prompt conditions stored in the user's management plan.

The methods of the disclosure are not limited to the exemplary steps 302-380 described herein. In other embodiments some or all of the described steps may be individually modified or omitted, as well as additional steps may be added. It will be also understood that at least some of the steps may be performed in parallel. By way of example, it will be understood that any of these steps may be performed in parallel, in series, or a combination thereof.

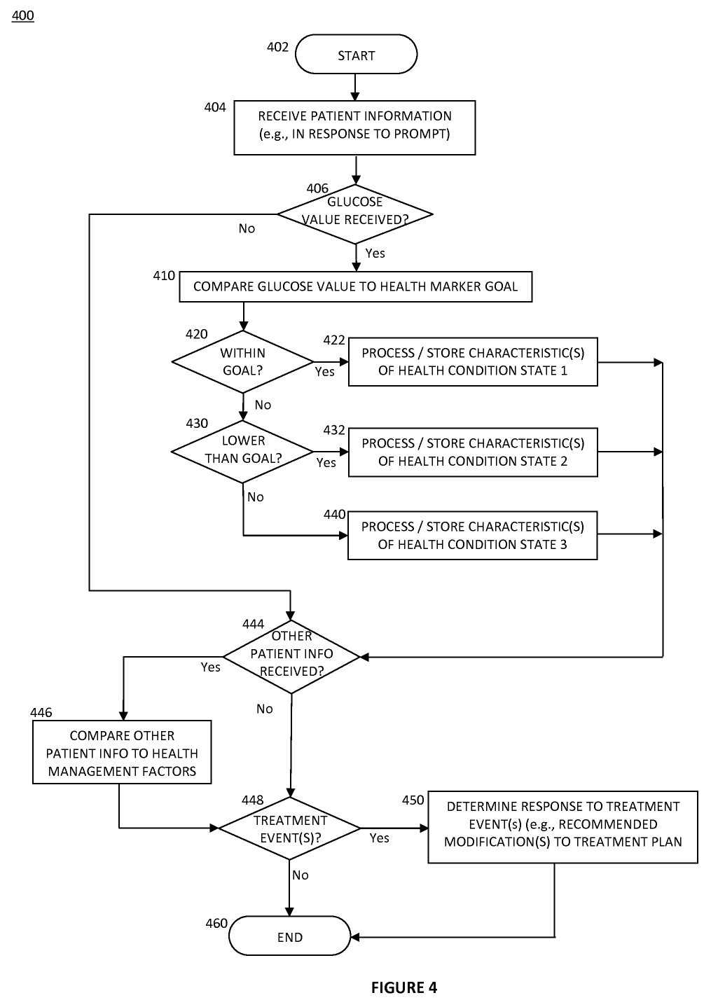

FIG. 4 shows an example of a method 400 for determining a treatment event and/or recommended changes to a treatment plan according to specific embodiments involving management of diabetes. It will be understood, however, that the method 400 may be modified for other health conditions and/or other health condition management plans. After initiation of the method 400 (start 402), the patient information is received at step 404. As discussed with respect to FIG. 3, the patient information may be received in response to a prompt to the patient, provider and/or other user. The patient information may also be received from various sources not in response to a prompt. In embodiments of FIG. 4, the patient information may include a health marker (e.g., glucose value) and/or other information relating to the patient.

As shown in FIG. 4, the method 400 may include the steps of comparing the collected patient information to one or more goals and comparing the collected patient information to one or more other health management factors to determine one or more treatment events. For example, if it is determined at step 406 that the received patient information includes a glucose value, the method 400 may compare the received glucose value to one or more health marker goals at step 410. In this manner, the dynamic health condition management system 120 may determine the state of the health condition of the patient based on one or more collected glucose values. The generated health condition management plan may provide a structured response based on the state of the health condition.

In this example, there may be three states of the health condition—state 1: within the goal range (individualized for each patient, depending on her/his profile); state 2: below the goal (relatively hypoglycemic); and state 3: above the goal (relatively hyperglycemic). In some embodiments, the dynamic health condition management plan 120 may consider state 1 to be desirable management; and may consider states 2 and 3 to be undesirable management of the health condition. Based on the determined state and characteristics of the state, the dynamic health condition management system 120 can provide a structured response in accordance with the generated plan. For example, the dynamic health condition management system 120 may provide a different response for glucose levels that are only slightly below goal and asymptomatic as compared to severe hypoglycemia associated with loss of consciousness and requiring assistance from others. However, it will be understood that the structured response may differ and may depend on the generated management plan for each individual patient.

Thus, following step 410, the method 400 may include a step 420 of determining whether the one or more glucose values are within the goal range of values. If it is determined at step 420 that the one or more glucose values are within the goal for this marker, the method 400 may proceed to a step 422 of processing and storing the characteristics of the patient's health condition state (i.e., within goal, and measured at a given time relative to the goal frequency of measurement within that patient's health condition management plan). For example, the one or more characteristics of the health condition state may relate to frequency of normality (e.g., patient's performance on the management plan (e.g., collection schedule, responding to prompts, etc.)). Thus, in step 422, the dynamic health condition management system 120 may determine whether one or more performance goals are also met (such as frequency and timing of measurements relative to a schedule requested by the provider). The characteristics of the state would thus include the performance of the patient as well as the health marker value, etc., along with comparisons relative to the latest profile and health marker and health condition management goals for each individual patient. Based on the one or more characteristics, the dynamic health condition management system 120 can determine whether there is a treatment event (step 448). In this example, if the dynamic health condition management system 120 determines there is a treatment event with respect to performance goal(s) (e.g., meeting one or more performance goal(s)), the system 120 may respond to the treatment event by updating one or more performance goal(s) and/or one or more prompt conditions in the patient's health condition management plan. For example, the system may reduce the frequency of routine prompts and/or may reset or adjust the one or more performance goals. On the other hand, if the dynamic health condition management system 120 determines that performance goal(s) are not met, the system 120 may respond to this treatment event by updating the patient's management plan to indicate that the patient was or was not adherent to the recommended plan for collecting glucose measurements with respect to this collection period. In this way, the dynamic health management system 120 may monitor and characterize the performance of the patient with the health condition management plan.

If it is determined at step 420 that the glucose value is not within the goal range of values, it may next be determined at step 430 whether the glucose value is below the goal range of values. If so, then method 400 may process and store the characteristics of the patient's health condition state (e.g. below goal) at step 432. For example, step 432 may include determining whether the glucose value corresponds to a hypoglycemic event and its associated relative priority for correction (e.g., hypoglycemia relative to goal but not hypoglycemia in absolute terms, vs. a mild hypoglycemic event with or without symptoms, vs. a severe hypoglycemic event requiring assistance from others). As another example, the one or more characteristics may include the degree of abnormality, the frequency of abnormality, and/or availability of explanatory reasoning. Depending on one or more characteristics (e.g., degree of the abnormality, the frequency of the abnormality, and/or the availability of explanatory reasoning) and other attribute(s), the dynamic health condition management system 120 can determine whether there is a treatment event with respect to health marker goal(s) and/or whether there is a treatment event with respect to performance goal(s) (step 448). The dynamic health condition management system 120 may then provide a response e.g., a recommended change to the management plan (step 450), based on the relative priority for correction.

If it is determined at step 430 that the glucose value is not lower than the goal range of values, this indicates that the glucose value must be higher than the goal range of value. In this case, the method 400 may process and store the characteristics of the patient's health condition state (e.g. above goal) at step 440. Step 440 may involve processing the characteristics to determine whether the glucose value corresponds to a hyperglycemic event and its associated relative priority for correction (e.g., a mild hyperglycemic event vs. a severe hyperglycemic event). For example, like the hypoglycemic event, the one or more characteristics may include the degree of abnormality, the frequency of abnormality, and/or availability of explanatory reasoning. Depending on one or more characteristics (e.g., degree of the abnormality, the frequency of the abnormality, and/or the availability of explanatory reasoning) and other attribute(s), the dynamic health condition management system 120 can determine whether there is a treatment event with respect to health marker goal(s) and/or whether there is a treatment event with respect to performance goal(s) (step 448). By way of example, explanatory reasons that can contribute to understanding of the potential causes of a hyperglycemic event can include inactivity, illness, emotional stress, improper medication administration, etc. Reasons that usually cannot account for hyperglycemia include increased physical activity. In this example, the system 120 may consider any reasoning that can contribute to understanding of a hyperglycemic event as plausible explanatory reasoning provided, and the system 120 may consider increased physical activity as implausible explanatory reasoning. The dynamic health condition management system 120 may then provide a response e.g., a recommended change to the management plan (step 450), based on the relative priority for correction.

After performing step 422, step 432 or step 440, as applicable, the method 400 may include a step 444 of determining whether any other patient information was received (step 404). If so, the other patient information is compared at step 446 to one or more other health management factors stored in the patient's health management plan to determine whether there is a change. For example, the patient information may indicate that the patient is pregnant, which may be a change from a previously stored health management factor. Next at step 448, it is determined whether the patient's health condition state (and characteristics thereof) or any changes in other health management factors results in or indicates a treatment event. If so, the method advances to step 450, where a response to the treatment event(s) is determined. As discussed, a response may be a recommended modification to the patient's treatment plan or updates to the patient management plan. After performing step 450 or if no treatment events determined in step 448, the exemplary method 400 may end (step 460).

Method 400 is shown and explained by way of example only. Some or all of the described steps of method 400 may be individually modified or omitted, as well as additional steps may be added. It will be also understood that at least some of the steps may be performed in parallel. By way of example, it will be understood that any of these steps may be performed in parallel, in series, or a combination thereof. Unless stated otherwise as apparent from the previous discussion, it will be appreciated that terms such as “comparing,” “generating,” “determining,” “obtaining,” “processing,” “computing,” “selecting,” “receiving,” “correcting,” “estimating,” “calculating,” “quantifying,” “outputting,” “acquiring,” “analyzing,” “retrieving,” “sorting,” “causing,” “transmitting,” “comparing,” “performing,” “predicting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

### III. METHOD AND SYSTEM IMPLEMENTATION

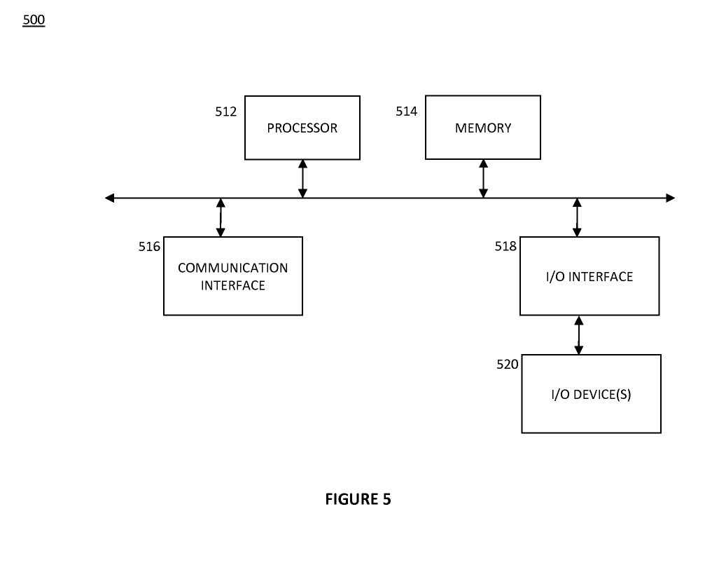

One or more of the devices and/or systems of dynamic health management system 100 may be and/or include a computer system and/or device. FIG. 5 is a block diagram showing an example of a computer system 500. The modules of the computer system 500 may be included in at least some of the systems and/or modules, as well as other devices and/or systems of the system 100.

The system for carrying out the embodiments of the methods disclosed herein is not limited to the systems shown in FIGS. 1 and 5. Other systems may also be used. It is also to be understood that the system 500 may omit any of the modules illustrated and/or may include additional modules not shown.

The system 500 shown in FIG. 5 may include any number of modules that communicate with each other through electrical or data connections (not shown). In some embodiments, the modules may be connected via any network (e.g., wired network, wireless network, or a combination thereof).

The system 500 may be a computing system, such as a workstation, computer, or the like. The system 500 may include one or more processors 512. The processor(s) 512 (also referred to as central processing units, or CPUs) may be any known central processing unit, a processor, or a microprocessor. The CPU 512 may be coupled directly or indirectly to one or more computer—readable storage media (e.g., memory) 514. The memory 514 may include random access memory (RAM), read only memory (ROM), disk drive, tape drive, etc., or a combinations thereof. The memory 514 may be configured to store programs and data, including data structures. In some embodiments, the memory 514 may also include a frame buffer for storing data arrays.

In some embodiments, another computer system may assume the data analysis or other functions of the CPU 512. In response to commands received from an input device, the programs or data stored in the memory 514 may be archived in long term storage or may be further processed by the processor and presented on a display.

In some embodiments, the system 510 may include a communication interface 516 configured to conduct receiving and transmitting of data between other modules on the system and/or network. The communication interface 516 may be a wired and/or wireless interface, a switched circuit wireless interface, a network of data processing devices, such as LAN, WAN, the internet, or combination thereof. The communication interface may be configured to execute various communication protocols, such as Bluetooth, wireless, and Ethernet, in order to establish and maintain communication with at least another module on the network.

In some embodiments, the system 510 may include an input/output interface 518 configured for receiving information from one or more input devices 520 (e.g., a keyboard, a mouse, and the like) and/or conveying information to one or more output devices 520 (e.g., a printer, a CD writer, a DVD writer, portable flash memory, etc.). In some embodiments, the one or more input devices 520 may be configured to control, for example, the generation of the management plan and/or prompt, the display of the management plan and/or prompt on a display, the printing of the management plan and/or prompt by a printer interface, the transmission of a management plan and/or prompt, among other things.

In some embodiments, the disclosed methods (e.g., FIGS. 2-4) may be implemented using software applications that are stored in a memory and executed by a processor (e.g., CPU) provided on the system 100. In some embodiments, the disclosed methods may be implemented using software applications that are stored in memories and executed by CPUs distributed across the system.

As such, any of the systems and/or modules of the system 100 may be a general purpose computer system, such as system 500, that becomes a specific purpose computer system when executing the routines and methods of the disclosure. The systems and/or modules of the system 100 may also include an operating system and micro instruction code. The various processes and functions described herein may either be part of the micro instruction code or part of the application program or routine (or combination thereof) that is executed via the operating system.

If written in a programming language conforming to a recognized standard, sequences of instructions designed to implement the methods may be compiled for execution on a variety of hardware systems and for interface to a variety of operating systems. In addition, embodiments are not described with reference to any particular programming language. It will be appreciated that a variety of programming languages may be used to implement embodiments of the disclosure. An example of hardware for performing the described functions is shown in FIGS. 1 and 5. It is to be further understood that, because some of the constituent system components and method steps depicted in the accompanying figures can be implemented in software, the actual connections between the systems components (or the process steps) may differ depending upon the manner in which the disclosure is programmed. Given the teachings of the disclosure provided herein, one of ordinary skill in the related art will be able to contemplate these and similar implementations or configurations of the disclosure.

### IV. EXAMPLES

FIG. 6 shows an example of user interface 600 showing generated prompt(s). In the example in FIG. 6, the prompt relates to a report to the provider for a patient with diabetes. As shown in FIG. 6, the dynamic health condition management system 120 analyzed the fasting glucose and pre- and post-meal glucose profile provided by the patient in comparison to the health marker goals associated with the management plan for the patient. In this example, each user interface includes areas 610 for data related to the health marker (e.g., profile and fasting glucose levels) for a patient; and areas 620 for the medication regimen for the patient at the time of the health marker assessment. Based on this information, the system 120 can generate medication regimen recommendations 630 and provide rationales for the recommendations 640. In addition, the system 120 can generate a graphical view 650 of the data for the patient (e.g., the data 610 and/or data not shown) for display.

In the example shown in FIG. 6, the pre-meal and bedtime glucose health marker goals for a patient were as follows:

i. Pre-breakfast: 75-100

ii. Pre-lunch: 80-120

iii. Pre-dinner: 80-120

iv. At bedtime: 110-150

Although not shown, post-meal goals are generally higher than pre-meal goals. In this example, the patient is currently taking 10 mg of glipizide at breakfast, lunch, and dinner, and 38 units of glargine at dinner. The dynamic health condition management system 120 can process the fasting glucose values for different collection periods. For one collection period, the dynamic health condition system 120 processes the fasting glucose value and compares it to the health marker goals, and determines that the fasting glucose value is below goal <75 mg/dl (65) and thereby determines that the event corresponds to a treatment event (hypoglycemia) because the glucose level was both below 75 mg/dl (goal glucose pre-breakfast) and below 70 mg/dl (an absolute criterion for mild hypoglycemia according to some studies). The dynamic health condition management system 120 then processes this treatment event and determines a recommendation for a change in the medication regimen—a decrease in the dinnertime glargine insulin dosage of 2 units.

The dynamic health condition management system 120 can also process the additional glucose values provided. The dynamic health condition management system 120 can process the latest glucose profile (pre- and post-meal glucose values) to determine whether there are any additional treatment events. The dynamic health condition management system 120 determines that a glucose level before lunch is above goal >120 (140) and thereby determines that the event corresponds to a treatment event (hyperglycemia). The dynamic health condition management system 120 then processes this treatment event to determine whether additional changes to the medication regimen should be made, for example, by “predicting” changes in glucose patterns according to changes in the management plan.

The dynamic health condition system 120 determines another medication regimen recommendation to increase glipizide to 12.5 mg at breakfast.

After the management plan is updated based on these recommendations, the dynamic health condition system 120 can process the additional glucose values received. The dynamic health condition system 120 determines that the glucose value before dinner is above goal >120 (146) and thereby determines that the event corresponds to a treatment event (hyperglycemia). The dynamic health condition management system 120 can then process this treatment event to determine whether additional change(s) to the medication regimen should be made. However, due to both decreasing the glargine before dinner and increasing the glipizide at breakfast, the dynamic health condition management system 120 now predicts that with these changes, the glucose value before dinner should fall to be within the goal range. As a result, the dynamic health condition management system 120 can determine that no additional changes to the management plan before lunch are needed (e.g., no glipizide dosage change would be recommended at lunch even though the pre-dinner glucose level, which is affected by the glipizide dosage before lunch, was above goal).

The dynamic health condition management system 120 then processes the glucose level measured at bedtime. Because the glucose value is at goal, the dynamic health condition management system 120 determines that no treatment event was present prior to the recommended changes in medications. Further, the dynamic health condition management system 120 can predict that as a result of the combination of changing the dosages of both the glargine before dinner and glipizide before breakfast, glucose levels at bedtime will remain within the goal range, and therefore makes no recommended changes to the glipizide dosage at suppertime.

As shown in the report (FIG. 6), the dynamic health condition management system 120 can provide the patient/provider with the final dosages that are recommended and/or implemented changes to the management plan, and provide rationales that can generally describe a justification for making the recommended changes in management. This can help to educate both the provider and patient, and may also help to improve patient adherence to the recommendations. For example, if the recommendation includes the addition of a new drug, the prompt to the provider may include choices of options, along with pros and cons of the different options that take into account both the individual goals, preferences, and history of that patient, and considerations based on the experience of other patients. Similar and appropriate information may also be transmitted to the patient, as needed for facilitation of shared clinical decision making. In some examples the recommendations transmitted to the provider can include any additional comments provided by the patient, along with important elements of the patient's history and current/past medical conditions for the provider's review.

In cases where the provider agrees with the recommended management plan (or specifies further modifications to it), the system can send the new plan to the patient for confirmation that the new plan has been received, along with rationales and education appropriate for that patient, and with or without alerts to the healthcare team that the patient may benefit from additional education and discussion of the proposed changes in management, if appropriate. If the patient agrees with the new management plan (e.g., changing the dosages of the medications), the provider can be notified that the patient has reviewed and agreed to the new plan for dosages of the medications. If the patient disagrees with or wants further discussion of the recommended changes in management plan, the patient can provide input to this effect, which will cause to the system to generate appropriate prompt(s) to the provider and healthcare team.

Based on the foregoing, it can be seen that the health condition management system 120 has the capability to automatically process real-time information and automatically incorporate individualized, optimized, up-to-date case management recommendations, including justifications based on relay of organized, analyzed patient data to healthcare teams and healthcare providers. The system 120 allows the patient and the provider to use the healthcare team to assist the provider and educate/engage the patient. The system 120 is also able to leverage the experiences and histories of multiple patients in order to optimize recommended courses of treatment for individual patients. The system is capable of automatically generating treatment recommendations and prompting providers for approval, rejection, or further modification of the recommendations before a revised health care management plan is transmitted to the patient. The capabilities of the system 120 thus far exceed the care potential resulting from patients speaking with healthcare providers at patient visits or otherwise trying to transmit information to their healthcare providers via telephone, fax, or other intermittent messaging strategies between visits.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claims.

1. A computer-implemented method of controlling the management of a health condition, the method comprising:
receiving input indicating a health marker value for a health marker associated with a health condition of a patient;
in response to receiving the input indicating the health marker value, accessing a database storing a health condition management plan associated with the patient;
comparing the health marker value to a health marker goal specified in the health condition management plan, wherein the health condition management plan specifies one or more goals, treatment regimen information, or one or more treatment events;
in response to and based at least in part on the comparison of the health marker value, determining from the health condition management plan, whether at least one of the treatment events has occurred;
in response to determining that at least one of the treatment events has occurred, determining a recommended change in the treatment regimen information;
generating a prompt indicating the recommended change to a healthcare provider charged with caring for the patient; and
in response to receiving input from the healthcare provider indicating acceptance or modification of the recommended change, generating a further prompt indicating instructions to the patient for implementing the recommended change as accepted or modified by the healthcare provider.

2. The computer-implemented method according to claim 1, wherein the input indicating the health marker value is received from a healthcare device.

3. The computer-implemented method according to claim 2, wherein the healthcare device is at least one of a self-monitoring marker meter, a medical monitoring device, a drug delivery pump, an activity tracker, a sleep tracker, a smartphone executing a health care application, a weight scale, an exercise machine, a thermometer, or a blood pressure cuff.

4. The computer-implemented method according to claim 1, wherein the input indicating the health marker value is received from input provided by the patient.

5. The computer-implemented method according to claim 1, wherein the input indicating the health marker value is received from an electronic health record system.

6. The computer-implemented method according to claim 1, wherein each of the treatment events represent a respective change in a state of the health condition of the patient.

7. The computer-implemented method according to claim 1, further comprising:
receiving further input indicating additional health condition data about the patient;
in response to receiving the further input, accessing the database and comparing the additional health condition data with at least one of the one or more goals, the treatment regimen information, or one or more attributes of the one or more treatment events specified in the health condition management plan;
in response to and based at least in part on said comparison of the additional health condition data, determining whether at least one other of the treatment events has occurred; and
in response to determining that at least one other of the treatment events has occurred, determining a further recommended change in at least one of the one or more goals, the treatment regimen information, or the one or more treatment events specified in the health condition management plan.

8. The computer-implemented method according to claim 7, wherein the further input is received from a patient profile associated with the patient.

9. The computer-implemented method according to claim 7, wherein the further input is received from an electronic health record system.

10. The computer-implemented method according to claim 7, further comprising:
accessing the database to store the additional health condition data; and
accessing the health marker value in a profile associated with the patient.

11. The computer-implemented method according to claim 7, wherein:
the health condition management plan further comprises prompt conditions for determining when to generate prompts to the patient or to the provider; and
the further recommended change is in at least one of the one or more goals, the treatment regimen information, the one or more treatment events, or at least one of the prompt conditions.

12. The computer-implemented method according to claim 1, wherein the treatment regimen information comprises at least one of: medication regimen information, dietary regimen information or physical activity regimen information.

13. The computer-implemented method according to claim 1, further comprising:
updating the health condition management plan to reflect the recommended change as accepted, rejected or modified by the healthcare provider; and
storing the updated health condition management plan in the database.

14. The computer-implemented method according to claim 1, wherein the health condition management plan is determined based at least in part on profiles of other patients with the same, similar or related health condition.

15. The computer-implemented method according to claim 1, wherein the health condition management plan is determined in part based at least in part on a prior history of the patient with medications currently being taken by the patient.

16. The computer-implemented method according to claim 1, wherein the health condition management plan is determined in part based at least in part on a prior history of the patient with medications previously taken by the patient.

17. The computer-implemented method according to claim 1, further comprising receiving input from the patient in response to the further prompt indicating the instructions to the patient, wherein the input from the patient indicates at least one of agreement, disagreement or a request for further information.

18. A non-transitory computer readable storage medium comprising program instruction stored thereon, wherein the program instructions are executable by a computer to cause the computer to control the management of a health condition by:
receiving input indicating a health marker value for a health marker associated with a health condition of a patient;
in response to receiving the input indicating the health marker value, accessing a database storing a health condition management plan associated with the patient and comparing the health marker value to a health marker goal specified in the health condition management plan, wherein the health condition management plan specifies one or more goals, treatment regimen information, and one or more treatment events;
in response to and based at least in part on the comparison of the health marker value, determining from the health condition management plan, whether at least one of the treatment events has occurred;
in response to determining that at least one of the treatment events has occurred, determining a recommended change in the treatment regimen information and generating a prompt indicating the recommended change to a healthcare provider charged with caring for the patient; and
in response to receiving input from the healthcare provider indicating acceptance or modification of the recommended change, generating a further prompt indicating instructions to the patient for implementing the recommended change as accepted or modified by the healthcare provider.

19. The non-transitory computer readable storage medium according to claim 18, wherein the input indicating the health marker value is received from: a healthcare device or an electronic health record system.

20-22. (canceled)

23. The non-transitory computer readable storage medium according to claim 18, further comprising program instructions that, when executed by the computer, cause the computer to control the management of a health condition by:
receiving further input indicating additional health condition data about the patient;
in response to receiving the further input, accessing the database and comparing the additional health condition data with at least one of the one or more goals, the treatment regimen information, or one or more attributes of the one or more treatment events specified in the health condition management plan;
in response to and based at least in part on said comparison of the additional health condition data, determining whether at least one other of the treatment events has occurred; and
in response to determining that at least one other of the treatment events has occurred, determining a further recommended change in at least one of the one or more goals, the treatment regimen information, or the one or more treatment events specified in the health condition management plan.

24-29. (canceled)
